(19) United States
(12) Patent Application Publication
(10) Pub. No.: US 2007/0010909 A1
(43) Pub. Date: Jan. 11, 2007

(54) Stocker

(76) Inventors: Anthony C. Bonora, Portola Valley, CA (US); Michael Krolak, Los Gatos, CA (US); Roger G. Hine, Menlo Park, CA (US)

Correspondence Address: O'MELVENY & MYERS, LLP, 275 BATTERY STREET, SUITE 2600, SAN FRANCISCO, CA, 94111-3305, US

(21) Appl. No.: 11/482,650

(22) Filed: Jul. 7, 2006

Related U.S. Application Data
(60) Provisional application No. 60/697,616, filed on Jul. 8, 2005.

(51) Int. Cl. G06F 7/00

(52) U.S. Cl. 700/228

(57) ABSTRACT

The present invention comprises a stocker for managing containers within a fabrication facility having a ceiling-based interbay material handling system a floor-based intrabay material handling system. In one embodiment, the stocker comprises a container storage area for storing at least one container, a ceiling-based input conveyor, a floor-based conveyor and a robotic mechanism. The ceiling-based input conveyor receives containers from the ceiling based interbay material handling system. The stocker's floor-based conveyor may comprise an output conveyor, an input conveyor or both, and moves containers between the stocker's container storage area and the floor-based intrabay material handling system. A robotic mechanism moves containers between the ceiling-based input conveyor, the container storage area and the floor-based conveyor.

### CLAIM OF PRIORITY

This application claims priority under 35 U.S.C. §119(e) to U.S. Provisional Patent Application No. 60/697,616, entitled “Improved Stocker and Controls for Use with Conveyor,” which was filed with the U.S. Patent & Trademark Office on Jul. 8, 2005, and which is incorporated in its entirely by reference herein.

### RELATED APPLICATION

This application is related to U.S. patent application Ser. No. 11/433,980, entitled “Modular Terminal for High-Throughput AMHS,” which was filed with the U.S. Patent & Trademark Office on May 15, 2006, and which is incorporated in its entirety by reference herein.

### FIELD OF THE INVENTION

The present invention generally comprises a container storage system. More specifically, the present invention comprises a stocker having multiple container input/output systems.

### BACKGROUND OF THE INVENTION

It is costly to deliver containers 2, such as Front Opening Unified Pods (FOUPs) and Standard Mechanical Interface (SMIF) pods, to processing tools 10 and load ports 12 in a semiconductor fabrication facility (fab). One method of delivering FOUPs and SMIF pods between processing tools is an Automated Material Handling System (AMHS).

An AMHS or transport system moves containers or cassettes of semiconductor wafers or flat panels (all referred to as containers herein) in a fab. Container movement within the fab may be within each tool bay (e.g., bays B1 and B2 in FIG. 1) (intrabay AMHS—generally comprises a transport system that moves containers within a bay and delivers containers to tool locations.) and between tool bays (interbay AMHS—generally comprises a transport system that moves containers along a main aisle that connects bays of processing tools.). Fabs often include stockers for storing containers. It is desirable to decrease delays in AMHS traffic by delivering containers directly from processing tool to processing tool as much as possible. Inadequate throughput capability in any part of the AMHS may cause other parts of the AMHS to have throughput that is below potential because the inadequate component is serially connected to the other parts.

Containers are often delivered to a stocker after a process step is completed and then later removed and delivered to another tool when the tool is ready. The limited throughput of a conventional stocker limits the entire throughput capacity of the systems that deliver and remove containers from a stocker. Thus, the overall throughput capacity of the AMHS is limited to the stocker throughput. For example, peak interbay transport throughput for a particular stocker may be 700 container or AMHS moves per hour. If this stocker is accessed by two material handling systems for bidirectional transport, a potential peak interbay move rate of 1400 container moves per hour for that particular stocker may theoretically be achieved. If this stocker is further connected to another tool bay having an intrabay AMHS or other transport system with a 700 container moves per hour peak capacity, the peak moves rate for the stocker could reach up to 2100 container moves per hour. A conventional stocker can only make one container move every twenty seconds on average—limiting the peak throughput of the stocker to 180 container moves per hour, which is well below what may be required by the fab.

Even if only considering the throughput of the bay, and the stocker only handles container flow into the bay, the peak requirement could be 1400 moves per hour (700 moves per hour from interbay, 700 moves per hour to intrabay). This situation would cause the high potential throughput of the intrabay to be severely limited by the stocker.

One type of conventional AMHS or transport system is an overhead transport (OHT) system. In an OHT system, an OHT vehicle, lowers a FOUP onto the kinematic plate of the load port at approximately 900 mm height from the fabrication facility floor. An OHT system uses sophisticated ceiling mounted tracks and cable hoist vehicles to deliver FOUPs to these load ports. The combination of horizontal moves, cable hoist extensions, and unidirectional operation, must be coordinated for transporting FOUPs quickly between processing tools. For optimum efficieny within an OHT system an OHT vehicle must be available at the instant when a processing tool needs to be loaded or unloaded. This is not always possible.

Other non-conveyor AMHS or transport systems that use a vehicle to move containers throughout the fab (e.g., automated guided vehicle (AGV) system, rail guided vehicle (RGV) systems, overhead shuttle (OHS) systems) require the AMHS scheduling system to manage the movement and availability of empty vehicles as well as the loaded vehicles that are making deliveries. This heavy burden on the scheduling system often results in container pick-up delays because empty vehicles are directed to the pick-up location and added traffic congestion results due to non-productive empty vehicle movement. Similar delays occur with OHT vehicles. The OHT vehicle may take, for example, fifteen seconds to complete the container pick-up or drop-off step, and during this pick-up/drop-off time, container traffic is blocked at that location of the AMHS. These factors combine to limit vehicle based intrabay AMHS to, for example, 100-200 moves per hour in many cases. This does not present a large mismatch with conventional stocker capabilities. However, many tool bays require much higher throughput that cannot be met with the conventional stocker/OHT architecture.

Therefore, there is a need for improved high-throughput stocker or container storage system within a fab. The present invention provides such a stocker and system.

### SUMMARY OF THE INVENTION

One aspect of the present invention is to provide a stocker that minimizes the amount of time a container waits or idles on the ceiling-based interbay conveyor after the container arrives at the stocker. In one embodiment, the stocker includes a ceiling-based input conveyor adjacent the ceiling-based interbay conveyor. The input conveyor may, for example, store multiple containers at one time; allowing a container arriving at the stocker to be transferred immediately to the input buffer conveyor. In another embodiment, the ceiling-based interbay conveyor comprise a dual level conveyor system. In this case, the stocker may have a ceiling-based input conveyor dedicated to each level of the ceiling-based interbay conveyor.

Another aspect of the present invention is to provide a stocker that includes input and output buffering capabilities dedicated to either a ceiling-based interbay conveyor or a floor-based intrabay conveyor. In one embodiment, the stocker includes a floor-based output conveyor for moving containers out of the stocker's container storage area and onto the floor-based intrabay conveyor. The stocker may also include a floor-based input conveyor for moving a container from the floor-based intrabay conveyor into the stocker's container storage area. A ceiling-based input conveyor is able to move containers either into the stocker's container storage area or to a vertical module (effectively bypassing the stocker). In one embodiment, the ceiling-based input conveyor may store multiple containers; providing a buffering area for containers moved off the ceiling-base interbay conveyor. The stocker may also include a ceiling-based output conveyor for buffering containers exiting the stocker, but before the container is moved to the ceiling-based interbay conveyor.

Yet another aspect of the present invention is to provide a stocker that supports the express delivery of high priority containers. In one embodiment, the stocker includes a vertical module that moves a container directly from the ceiling-based interbay conveyor or ceiling-based input conveyor to the floor-based intrabay conveyor. In other words, the container does not have to enter the stocker's container storage area in order to be transferred to the floor-based conveyor. In another embodiment, the vertical module is also able to move a container placed on a shelf from an OHT vehicle directly to the floor-based conveyor.

Another aspect of the present invention is to provide a method of synchronizing and delivering groups of containers from a ceiling-based interbay conveyor to the stocker.

### BRIEF DESCRIPTION OF THE DRAWINGS

FIG. 1 provides a plan view of a representative system, according to one embodiment of the present invention;

FIG. 2 provides a plan view of a representative system, according to another embodiment of the present invention;

FIG. 3 provides a perspective view of one embodiment of a stocker, according to the present invention; and

FIG. 4 provides a perspective view of another embodiment of a stocker, according to the present invention.

### DETAILED DESCRIPTION OF THE INVENTION

For exemplary purposes only, the present invention will be described herein in conjunction with transporting FOUPs. The various embodiments of the present invention may also be used and/or adapted for systems handling SMIF pods, reticle containers, flat panel display transport devices, or any other container or processing tool. Container is defined as any structure for supporting an article including, but not limited to, a semiconductor substrate of any size (e.g., 50 mm to 500 mm wafers). By way of example only, a container includes a structure that comprises an open volume whereby the article can be accessed (e.g., FPD transport) or a container having a mechanically openable door (e.g., bottom opening SMIF pod and FOUP). Load port is defined as any interface equipment that handles containers.

The present invention will also be described in conjunction with conveyors for ease of describing the various embodiments. The present invention may also operate, of course, with other AMHS or other transport system such as an OHT vehicle, an overhead shuttle (OHS), an RGV or an AGV. For purposes of describing the various embodiments of the present invention, “ceiling-based” is intended to define any height equal to or above the container loading height of a load port. And “floor-based” is intended to define any height below the container loading height of a load port, including under the fab floor.

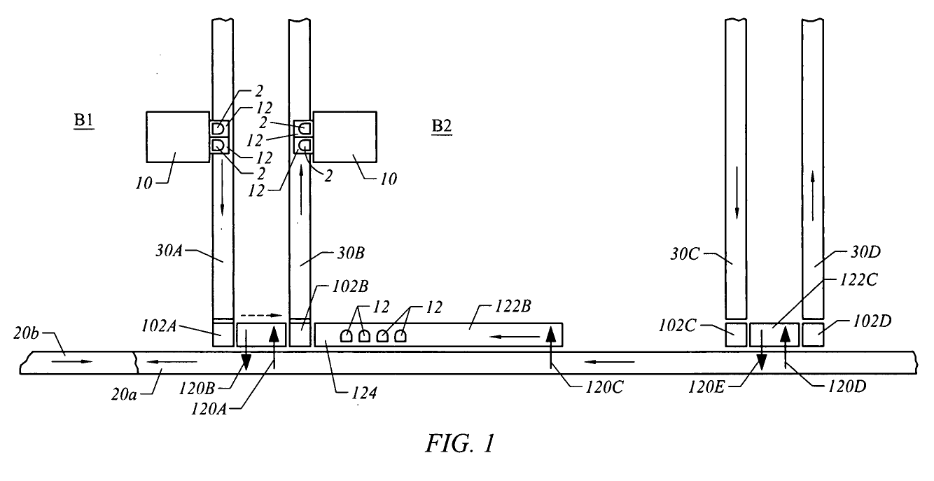

FIG. 1 illustrates an AMHS 100 utilizing various components of the present invention to improve the overall throughput of containers 2 within the fabrication facility. The AMHS 100 includes a first ceiling-based interbay conveyor 20a, a second ceiling-based interbay conveyor 20b, multiple floor-based intrabay conveyors 30, two tool bays B1 and B2, multiple ceiling-based buffer conveyors 122 and multiple lane jumpers 120. In this embodiment, the two ceiling based conveyors 20 are vertically stacked and each moves containers 2 in one direction (as shown by the arrows in FIG. 1). Each ceiling-based conveyor 20 may also be bidirectional. Each tool bay shown in FIG. 1 includes a process tool 10 having two load ports 12. Each tool bay may have more than one process tool 10, and each process tool may have any number of load ports 12.

A conveyor may comprise any system of wheels, rollers, belts or slides that can push a container in a guided linear manner. For example, the ceiling-based conveyors 20 may be asynchronous; comprising individual segments that can each have their speed and direction independently controlled to move containers at different rates, or even to be stationary while other containers are moving on the conveyor.

FIG. 1 illustrates four floor-based conveyors 30. Floor-based conveyor 30A provides a path to the ceiling-based conveyor 20 from the tool bay B1. Floor-based conveyor 30B provides a path from the ceiling-based conveyor 20 to the tool bay B2. These two intrabay conveyors 30A and 30B each also transport containers between load ports 12 within its respective tool bay B1 and B2. Floor-based conveyor 30C and 30D operate in a similar manner. Floor-based conveyor 30C provides a path to the ceiling-based conveyor 20. Floor-based conveyor 30D provides a path away from the ceiling-based conveyor 20.

FIG. 1 also illustrates four vertical modules 102. Each vertical module 102 moves containers between a ceiling-based conveyor 20 and a floor-based conveyor 30. A vertical module may also move containers 2 between a conveyor (ceiling or floor based) and a storage shelf. Various embodiments of a vertical module 102 are described in U.S. application Ser. No. 11/433,980, entitled “Modular Terminal for High-Throughput AMHS,” which has been assigned to Asyst Technologies, Inc, and is incorporated herein by reference. The vertical module 102A transfers containers 2 between either ceiling-based conveyor 20 and the floor-based conveyor 30A. The vertical module 102B transfers containers 2 between either ceiling-based conveyor 20 and the floor-based conveyor 30B. The vertical module 102C transfers containers 2 between either ceiling-based conveyor 20 and the floor-based conveyor 30C. The vertical module 102D transfers containers 2 between either ceiling-based conveyor 20 and the floor-based conveyor 30D.

The system 100 also contains three buffer conveyors 122. Each buffer conveyor 122 is adjacent a ceiling-based conveyor 20 so that a container 2 may be easily transferred between a buffer conveyor 122 and a ceiling-based conveyor 20. If the ceiling-based conveyor 20 comprises a dual level conveyor, as shown in FIG. 1, a buffer conveyor 122 may be located adjacent each conveyor level. In this configuration, a first buffer conveyor 122A is located at a height adjacent the ceiling-based conveyor 20a, and is horizontally aligned (from a plan view) between vertical module 102A and vertical module 102B. A second buffer conveyor 122B is also located at a height adjacent the ceiling-based conveyor 20a, and is horizontally aligned such that one end 124 of the buffer conveyor 122B is located near the vertical module 102B. A third buffer conveyor 122C is located at a height adjacent the ceiling-based conveyor 20a, and is horizontally aligned (from a plan view) between vertical module 102C and vertical module 102D.

A lane jumper 120 moves containers 2 between the ceiling-based conveyor 20 and a buffer conveyor 122. A lane jumper 120 may comprise any mechanism that transfers a container between two parallel conveyors. For example, any mechanism whereby the container on the first conveyor is gripped and lifted, then moved over the second conveyor, where it is lowered onto the second conveyor. These movements may be accomplished by a single or multi-segmented arm, or by a linear slide. In addition, a separate mechanism could be used to lift the container from underneath, allowing more variations in the design of the lateral transfer mechanism.

FIG. 1 illustrates a lane jumper 120A for moving containers from the ceiling-based conveyor 20 onto the buffer conveyor 122A and a lane jumper 120B for moving containers from the buffer conveyor 122A onto the ceiling-based conveyor 20. Buffer conveyor 122B includes one lane jumper 120C for moving containers from the ceiling-based conveyor 20 onto the buffer conveyor 122B. Lane jumper 120D moves containers from the ceiling-based conveyor 20 onto the buffer conveyor 122C and a lane jumper 120E for moving containers from the buffer conveyor 122A back onto the ceiling-based conveyor 20.

Each lane jumper 120 is preferably located at the input end of the input buffer 122 for lifting an incoming container off the interbay conveyor 20 independent of the operation of the vertical module 102 located at the other end of the buffer conveyor 122. A lane jumper 120 minimizes the delay to interbay conveyor traffic because traffic is blocked only while the lane jumper 120 is lifting the container 2 and shifting it laterally clear of the interbay traffic. The lane jumper lateral motion may include sensors or position monitoring circuits that can signal when the transferring container is clear of interbay traffic, even before the lateral motion has reached the buffer conveyor 122.

The length of the input buffer, for example, buffer conveyor 122B, is preferably long enough to allow the queuing of multiple containers. The ability to buffer multiple containers adjacent the ceiling-based conveyor 20 accommodates periods of time when the unloading rate of containers from the interbay conveyor 20 exceeds the rate at which containers exit the buffer conveyor 122B through the vertical module 120B. For example, the vertical module 102B may, temporarily, not be able to keep up with the rate of container transfer from the ceiling-based conveyor 20 to the buffer conveyor 122B or the facility control system is not requesting that tools be loaded at as high a rate as it is requesting the loading of the buffer conveyor 122B.

The system provides other buffering features. For example, containers 2 exiting the tool bay B1 may queue on the floor-based conveyor 30A in front of the exit vertical module 102A, if necessary. The exit vertical module 102A can transfer the containers 2 up to the buffer conveyor 122A located between the vertical modules 102A and 120B. The container 2 can eventually be transferred back the interbay conveyor 20 by lane jumper 120B at a time that causes minimal, or no traffic delays on the interbay conveyor 20. These sections of conveyor located between the vertical modules 102 (e.g., buffer conveyors 122A and 122C) could also be used as an entrance position for high priority (“hot lot”) containers or for transferring a container to the input vertical module (e.g., vertical modules 102B and 120D) for processing by another tool in the bay. It is also possible for containers to flow in a continuous loop in this manner, until they are loaded onto a tool.

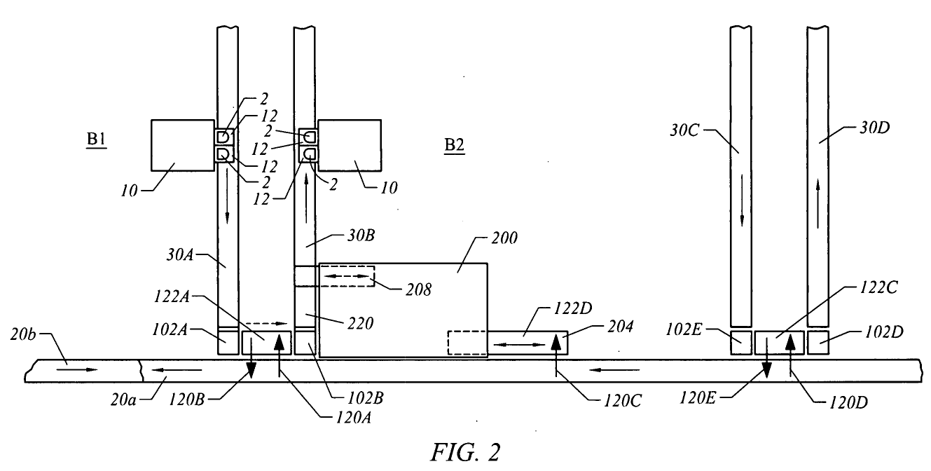

FIG. 2 illustrates the system 100 shown in FIG. 1 with a stocker 200 (discussed in more detail later) in place of the buffer conveyor 122B. The stocker 200 includes many of the basic functions of a conventional stocker. In one embodiment, the stocker 200 includes a robotic mechanism (not shown) that moves vertically and horizontally to access walls of storage shelves positioned within the stocker 200 (e.g., a container storage area). Such a robotic mechanism is well known in the semiconductor industry and therefore, a further description of the robotic mechanism is not necessary. One disadvantage of a conventional stocker is that the robotic mechanism may be transferring containers within the container storage area at the time that a container arrives at the stocker on the interbay conveyor 20. For example, if the stocker's robotic mechanism just started a transfer operation right before the container arrived, it may be 10 to 30 seconds before the robotic mechanism is free to retrieve the container waiting at the interbay conveyor 20. During that waiting time, the interbay traffic would be stopped and likely backed up on the conveyor 20. This inefficiency can greatly reduce the inherent high throughput of the conveyor 20.

FIG. 2 illustrates the stocker 200 in operation with the floor-based conveyor 30B that moves containers into tool bay B2. The stocker 200 may also be placed adjacent the floor-based conveyor 30A that moves containers out of tool bay B1. It is also within the scope of the present invention to place a stocker 200 in operation with both the floor-based conveyors 30A and 30B.

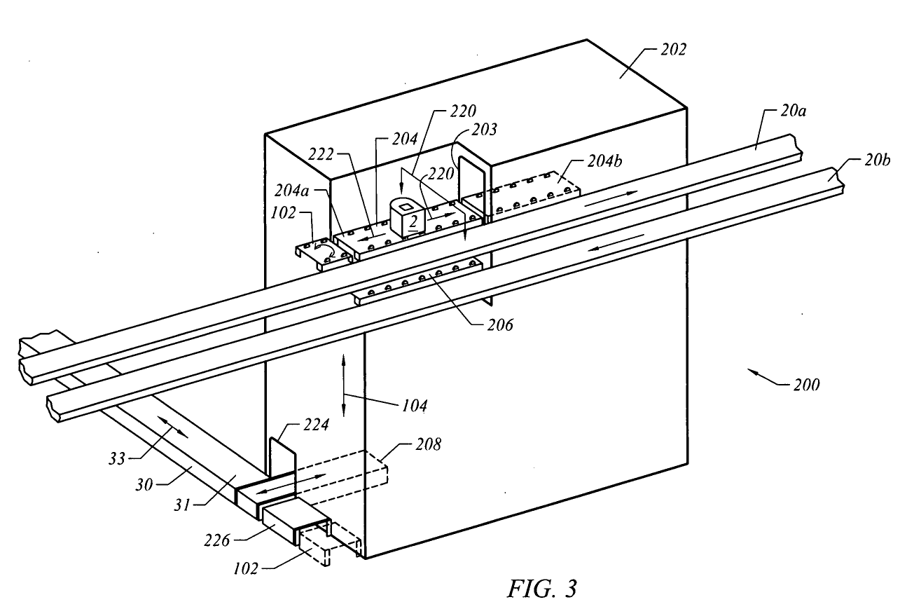

FIG. 3 illustrates the stocker 200 in more detail. In the FIG. 3 embodiment, the stocker 200 includes a housing 202, a first ceiling-based input conveyor 204, a second ceiling-based input conveyor 206 and a floor-based conveyor 208. Containers are stored within the housing 202, which provides a container storage area. Container storage within a stocker device (e.g., storage shelves) is well known within the semiconductor art and therefore, no further description is necessary. By way of example only, the container storage area may comprise a system similar to that disclosed in U.S. Pat. No. 6,579,052, entitled “SMIF Pod Storage, Retrieval and Delivery System,” which is assigned to Asyst Technologies, Inc., and is incorporated in its entirety herein.

The stocker 200 includes a ceiling-based input conveyor dedicated to each interbay conveyor 20. The first ceiling-based input conveyor 204 is preferably located at the same height or elevation as the interbay conveyor 20a. The second ceiling-based input conveyor 206 is preferably located at the same height or elevation as the interbay conveyor 20b. Each input conveyor may be located at other heights. Locating the input conveyor 204 at substantially the same height as the interbay conveyor 20a does, however, require fewer moves by the lane jumper 120 to transfer containers 2 between the input conveyor 204 and the interbay conveyor 20a.

The input conveyors 204 and 206 preferably extend into the stocker's container storage area. For example, input conveyor 204 includes a first section 204a located outside or external to the housing 202 and a second section 204b located within the housing 202. This way, the stocker's robotic mechanism (not shown) may access a container located in the internal section 204b of the input conveyor 204. The input conveyor 206 preferably includes the same features as the input conveyor 204. Other configurations of the input conveyors 204 and 206 may exist, and each input conveyor does not have to be identical or have the same features.

The input conveyor 204 is able to move a container either into the stocker housing 202 (see arrow 220) through the opening 203 or away from the stocker housing 202 (see arrow 222). Once a container 2 is inside the housing 202, the stocker's robotic mechanism is primarily responsible for moving the container between the input conveyors 204 and 206, the floor-based conveyor 208 and the storage shelves (not shown) located within the container storage area or housing 202.

The floor-based conveyor 208 may either comprise an output conveyor or an input conveyor. Either way, the floor-based conveyor 208 is preferably located at substantially the same height or elevation as the floor-based conveyor 30. If the conveyor 208 comprises an output conveyor, the stocker's robotic mechanism delivers a container 2 onto the output conveyor 208, and the output conveyor 208 moves the container 2 onto the intrabay conveyor 30 through the opening 224. If the conveyor 208 comprises an input conveyor, the input conveyor 208 moves a container 2 from the intrabay conveyor 30 into the stocker's container storage area through the opening 224. The stocker's robotic mechanism may then proceed to move the container within the stocker's container storage area.

FIG. 3 illustrates that the intrabay conveyor 30 is a bidirectional conveyor (see arrow 33). Thus, the conveyor 208 may also comprise a bidirectional conveyor. If the conveyor 30 comprises a unidirectional conveyor, then the conveyor 208 will comprise an input or output conveyor depending on the direction of the intrabay conveyor 30. The output conveyor 208 may also comprise any length, and in a preferred embodiment, may simultaneously store more than one container at a time.

Each of the stocker's conveyors may also provide a container buffer system similar to the buffer conveyors 122 shown in FIGS. 1-2. In a preferred embodiment, the input conveyors 204 and 206 and the conveyor 208 may each store more than one container at a time. The length of each stocker conveyor may vary.

The FIG. 3 embodiment of the stocker 200 includes a vertical module 102. The vertical module 102 transports containers 2 between the input conveyor 204, the input conveyor 206 and the floor-based conveyor 30. After a container 2 is placed on, for example, the input conveyor 204, the input conveyor 204 may deliver the container 2 inside the stocker 200 or to the vertical module 102. Transferring the container 2 to the vertical module 102 bypasses the stocker 200 and provides an express transfer to the floor-based conveyor 30. Otherwise, the container 2 must travel through the stocker 200 to get to the floor-based conveyor 30. The vertical module 102 also eliminates the need for a separate lane jumper 120 or other transfer device for transferring a container directly from the input conveyor 204 or 206 to the vertical module 102. The stocker 200 also preferably includes a transition conveyor 226 for moving a container 2 between the vertical module 102 and the conveyor 208.

A conventional stocker includes a single opening that both entering and exiting containers must pass through. To optimize the throughput efficiency of the stocker 200, the stocker 200 includes a conveyor control system responsible for coordinating container traffic at the points where the output conveyor 208 loads containers 2 onto the floor-based conveyor 30 (or conveyor 208 inputs containers into the container storage area) and containers are loaded onto the input conveyors 204 and 206.

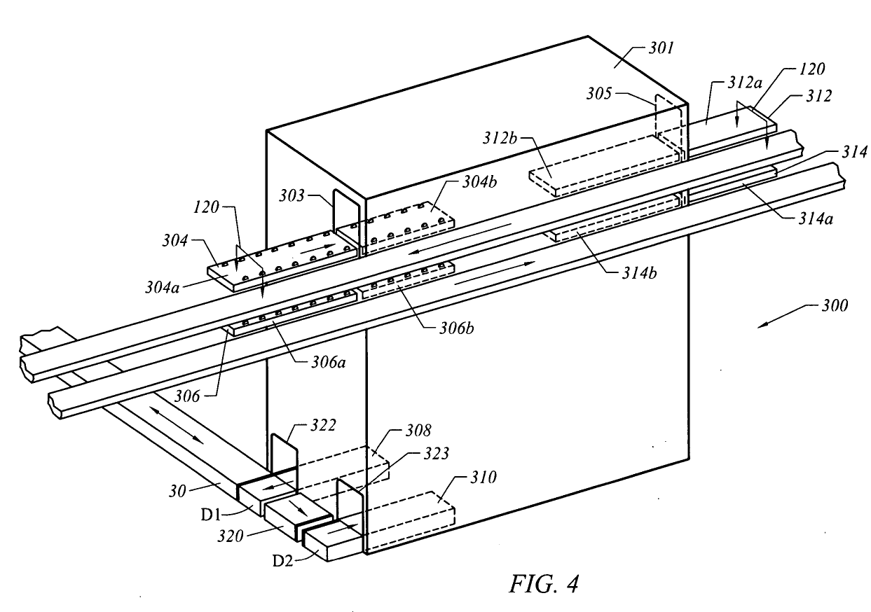

FIG. 4 illustrates a stocker 300. The stocker 300 is shown in operation with a bi-directional floor-based conveyor 30. The stocker 300 includes a housing 301 and several ceiling-based buffer conveyors: a first input buffer conveyor 304, a second input buffer conveyor 306, a first output conveyor 312 and a second output conveyor 314. The stocker 300 also includes two floor-based buffer conveyors: and output conveyor 308 and a floor-based input conveyor 310. The stocker 300 may have any combination of these conveyors.

In this embodiment, the stocker 300 includes a ceiling-based input buffer conveyor and an output buffer conveyor at both levels of the ceiling-based conveyor 20. The first input buffer conveyor 304 is located at the same height of, and is adjacent to, the ceiling-based conveyor 20a. The second input buffer conveyor 306 is located at the same height of, and is adjacent to, the ceiling-based conveyor 20b. The first output buffer conveyor 312 is located at the same height of, and is adjacent to, the ceiling-based conveyor 20a. The second output buffer conveyor 314 is located at the same height of, and is adjacent to, the ceiling-based conveyor 20b.

Each ceiling-based conveyor includes a section external to the stocker housing 302 and a section internal to or within the stocker housing 302. For example, the input conveyor 304 includes a section 304a external to the stocker housing 302 and a section 304b located within the stocker housing 302. As disclosed above, the stocker's robotic mechanism is able to access a container 2 seated anywhere on the internal section 304b of the input conveyor 304 or the internal section 306b of the input conveyor 306. The stocker's robotic mechanism may also place a container 2 anywhere on the internal section 312b of the output conveyor 312 or the internal section 314b of the output conveyor 314.

Each of the input and output buffer conveyors, in a preferred embodiment, includes at least one dedicated lane jumper 120, for transferring containers between the input or output buffer conveyor and the respective ceiling-based conveyor 20. In a preferred embodiment, and as previously described above, the input conveyors 304 and 306 and the output conveyors 312 and 314 each extend into the stocker at least one shelf location to allow the stocker's robotic mechanism (not shown) access to each conveyor. The input buffer conveyor 304 is preferably longer than the output buffer conveyor 312 to accommodate a period when a lane jumper 120 is loading containers from the ceiling-based conveyor 20 onto the input buffer conveyor 304 at a rate that is higher than the stocker 300 can accept. This situation will occur when the stocker robotic mechanism cannot move containers 2 from the input buffer conveyor 304 into the stocker 300 at the same rate as containers are bring placed on the input buffer conveyor 304. The input conveyor 306 preferably has the same features as the input conveyor 304.

The stocker 300 is not required to include two floor-based buffer conveyors. The stocker 300 may, for example, include a single bidirectional floor-based buffer conveyor (e.g., conveyor 308 may be bidirectional). However, the efficiency of the stocker 300 is improved by having a dedicated floor-based input and output conveyor. In a preferred embodiment, the stocker 300 includes two floor-based conveyors: an input buffer conveyor 310 and a floor based output buffer conveyor 308. The output conveyor 308 moves a container, placed on it by the stocker's robotic mechanism, onto the floor-based conveyor 30. The input conveyor 310 moves containers from the floor-based conveyor 30 into the stocker housing 302.

The floor-based buffer conveyors 308 and 310 allow containers 2 to be collected in a group without interfering with the container traffic on the floor-based conveyor 30. For example, multiple containers 2 may be transferred on the floor-based conveyor 30 in groups into the tool bay (e.g., away from the director D1), and then transfer the multiple containers back to the stocker 300 all at the same time. Another efficient container transfer method is to send a container 2 from the stocker 300 into the tool bay, and then allow a container waiting in the tool bay to be transferred back to the stocker 300 as soon as the outgoing container has passed the waiting container. There may be times when the floor-based conveyor 30 has some sections moving in opposite direction (e.g., asynchronous conveyor). The stocker 300 may support either container transfer method.

The stocker 300 includes a director D1 located adjacent the floor-based output conveyor 308, a director D2 located adjacent the floor-based input conveyor 310 and a transition conveyor 320 for transferring containers 2 from the director D1 to the director D2. The director D1 is able to rotate a container 2 exiting the output conveyor 308 before the intrabay conveyor 30 transports the container 2 to the tool bay. The director D2 is able to rotate a container 2 exiting the transition conveyor 208 before the container is transported into the stocker housing 302 by the input conveyor 310.

The floor-based buffer conveyors 308 and 310 may also be of any length, and the length of each conveyor, in part, determines how many containers 2 may be returned from the tool bay at one time. For example, for the most efficient stocker 300, the number of containers 2 returning from the tool bay at once should not be more that the total number of containers that can be stored on the floor-based input buffer conveyor 310, the transition conveyor 320 and the director D2. If more containers are returned than can be stored on the input conveyor 310, the transition conveyor 320 and the director D2, containers will back up to the point where the containers 2 will block the exit 322 of the output conveyor 308. If this happens, the output buffer conveyor 308 cannot move any containers onto the intrabay conveyor 30 and into the tool bay.

Preferably, as soon as the last of the returning containers 2 passes the director D1 and reaches the transition conveyor 320, the output conveyor 308 may start moving outgoing containers onto the intrabay conveyor 30 and into the tool bay. While the outgoing containers are traveling on the intrabay conveyor 30, the stocker's robot mechanism is free to load containers from the input conveyor 310, the input conveyor 304 or the input conveyor 306 into the stocker 300, if any containers are waiting. The stocker's robotic mechanism preferably moves containers from the input conveyor 310 into the stocker 300 until at least one container space is available on the transition conveyor 320 before moving outgoing containers onto the floor-based outgoing conveyor 308.

Containers may also be sent into the tool bay and back to the stocker 300 one at a time. For example, when an outgoing container traveling on the floor-based conveyor 30 clears or passes another container waiting to return to the stocker 300 (e.g., seated on a tool waiting to return to the stocker), the waiting container may be loaded onto the floor-based conveyor 30 and begin traveling towards the stocker 300. Each waiting container may start its movement back towards the stocker 300 as soon as the conveyor section between its position and the stocker 300 is clear of the last outgoing container. Ideally, by the time all of the containers return to the stocker's input buffer conveyor 310, the next set of outgoing containers have been staged on the output buffer conveyor 308, and this cycle would start again.

FIGS. 1-4 each illustrate the interbay conveyor 20 as vertically stacked conveyors 20a and 20b because a stacked configuration eliminates delays experienced by conventional planar interbay conveyors. Conventional interbay AMHS deliver containers most efficiently through uni-directional motion. Thus, multiple, parallel interbay conveyors increase the interbay AMHS throughput capacity. Planar interbay conveyor architecture does not, however, allow the containers from the more distant conveyor (e.g., conveyor located further from the tool bay) to enter a tool bay without crossing over the conveyor that is closer to the tool bay. These positions where conveyor flow is diverted or where conveyor flow crosses another conveyor requires a device such as a director. Interbay throughput would be degraded by the traffic interruptions.

The various embodiments of stockers disclosed herein could work with planar interbay conveyors. However, the efficiency of the system 100 would be reduced. If the system 100 contained planar interbay conveyors, directors would be installed to connect the far interbay conveyor to the position where a lane jumper 120 would remove a container 2 from the near interbay conveyor. It is even possible for the ceiling-based interbay conveyor 20 to interface with the stocker 200 or 300 without lane jumpers. The lane jumpers could be replaced by, for example, directors on the buffer conveyors 122, and container traffic would be connected to the position where the lane jumper had been, through another director on the adjacent interbay conveyor.

The various embodiments of stockers disclosed herein could also work with an OHS interbay AMHS. For example, the lane jumper 120 that would have interfaced with the interbay conveyor 20 would load and unload the containers 2 to and from the OHS vehicle. If the OHS vehicle had a transfer arm, it could directly load and unload containers to and from the buffer conveyors 122.

An interbay conveyor 20 may also be required to interface with conventional stockers that do not have the improved buffer architectures described above. In this case, container traffic on the interbay conveyor 20 will be blocked when a container is waiting on the conveyor 20 to be transferred to the stocker. Other containers traveling on the ceiling-based conveyor 20 cannot pass the stocker until the container is removed from the conveyor 20. The container may sit in the conveyor 20 while the stocker's robotic mechanism is, for example, moving a container within the stocker. These delays will reduce the throughput on the interbay conveyor 20.

One method of reducing these throughput delays on the interbay conveyor 20 is to have an interbay AMHS controller calculate when a container will arrive at the conventional stocker and provide that information to the stocker. The stocker will then know ahead of time when a container will arrive. Ideally, the stocker will not start a new operation that cannot be completed prior to the arrival of the container. The stocker's robotic mechanism or other robotic mechanism will therefore be ready to transport the container into the stocker when the container arrives. This method places a priority on the servicing of interbay containers at the expense of potential inefficiency of the stocker (e.g., the stocker robotic mechanism may wait prior to the arrival of the container instead of starting to move a container within the stocker).

Reducing delays and obstructions on the interbay conveyor 20 while containers are moving on the interbay conveyor 20 is important. An interbay controller would preferably reduce or eliminate obstructions due to containers being loaded onto the interbay. This could be accomplished by having the interbay conveyor 20 alternate between times when container motion is stopped so that containers may be loaded onto the interbay conveyor 20, and times when the containers are moving to their destinations on the interbay conveyor 20. To optimize the efficiency of the ceiling-based conveyor 20, the time period while containers are loaded onto the interbay conveyor 20 is preferably as short as possible because this period requires obstructing the conveyor. To shorten the amount of time required to load containers onto the conveyor 20, it is preferable to use multiple loading devices or mechanisms, in parallel, as possible. For example, multiple lane jumpers or directors at each loading bay could be used in parallel from loading containers onto the conveyor 20. Alternately, the containers may be queued on a buffer conveyor; allowing a single mechanism to load the containers onto the interbay conveyor 20 as quickly as possible.

The container loading period could end, by way of example only, either when a time interval was complete (e.g., load as many containers as possible onto the conveyor 20 in one minute), when all containers are loaded onto the conveyor 20, or when a maximum number of containers have been loaded onto the conveyor 20. After any of these periods, the containers loaded onto the conveyor 20 could begin moving. All the containers may move along the conveyor 20 until a time interval was complete or until all of the containers have been unloaded from the interbay conveyor 20 onto, for example, the stocker's ceiling-based input conveyor 204. If the containers move for a predetermined time period, any containers that have not yet been unloaded from the conveyor when the time period expires may move forward to another position that does not obstruct container loading operations, and stop. In this scenario, the container loading period would then begin again.

The above embodiments of a stocker are described and illustrated in operation with ceiling-based conveyors 20 and floor-based conveyors 30. It is within the scope and spirit of the present invention for the stocker to operate in conjunction with other material transport systems. For example, the ceiling-based conveyors 20 may instead be replaced by an overhead hoist transport (OHT) system or an overhead shuttle (OHS) system. Similarly, the floor-based conveyors 30 may instead be replaced by a rail guided vehicle (RGV), an automated guided vehicle (AGV) and so on.

It should be appreciated that the above-described stocker and methods for FOUP transport are for explanatory purposes only and that the invention is not limited thereby. Having thus described a preferred embodiment of a stocker and method for coordinating FOUP transportation, it should be apparent to those skilled in the art that certain advantages of the within system have been achieved. It should also be appreciated that various modifications, adaptations, and alternative embodiments thereof may be made within the scope and spirit of the present invention. For example, the use of conveyors has been illustrated in a semiconductor fabrication facility, but it should be apparent that many of the inventive concepts described above would be equally applicable to be used in connection with other non-semiconductor manufacturing applications.

We claim:

1. A stocker within a fabrication facility having a ceiling-based interbay material transport system for moving a container between tool bays and a floor-based intrabay material transport system for moving a container within a tool bay, the stocker comprising:
a container storage area for storing at least one container;
a ceiling-based input conveyor being adapted to receive a container from the ceiling-based interbay material handling system and moving the container into said container storage area;
a floor-based conveyor for moving a container between said container storage area and the floor-based intrabay material handling system; and
a robotic mechanism for moving a container between said ceiling-based input conveyor, said container storage area and said floor-based conveyor.

2. The stocker as recited in claim 1, wherein said container storage area comprises a plurality of container storage shelves.

3. The stocker as recited in claim 2, wherein said robotic mechanism also moves containers between said plurality of container storage shelves.

4. The stocker as recited in claim 1, further including a vertical transfer module for transferring a container between said ceiling-based input conveyor and the floor-based intrabay material handling system.

5. The stocker as recited in claim 1, wherein said floor-based conveyor comprises an input conveyor for moving a container from the floor-based intrabay material handling system into said container storage area.

6. The stocker as recited in claim 1, wherein said floor-based conveyor comprises an output conveyor for moving a container from said container storage area onto the floor-based intrabay material handling system.

7. The stocker as recited in claim 4, wherein said ceiling-based input conveyor further being adapted to move a container onto said vertical transfer module.

8. A stocker within a fabrication facility having a ceiling-based interbay material handling system for moving a container between tool bays and a floor-based intrabay material handling system for moving a container within a tool bay, comprising:
a container storage area;
a ceiling-based input conveyor for receiving a container from the ceiling-based interbay material handling system and moving the container into said container storage area;
a ceiling-based output conveyor for moving a container out of said container storage area;
a floor-based input conveyor for moving a container from the floor-based intrabay material handling system into said container storage area; and
a floor-based output conveyor for moving a container from said container storage area onto the floor-based intrabay material handling system; and
a robotic mechanism for moving a container between said ceiling-based input conveyor, said ceiling based output conveyor, said floor-based input conveyor, said floor-based output conveyor and within said container storage area.

9. The stocker as recited in claim 8, wherein said container storage area comprises a plurality of container storage shelves.

10. The stocker as recited in claim 9, wherein said robotic mechanism moves containers between said plurality of container storage shelves.

11. A method for optimizing container movement along a material handling system between a loading zone portion of the material handling system and a stocker, comprising the steps of:
(a) preparing the loading zone portion of the material handling system for receiving multiple containers;
(b) loading multiple containers, in parallel, onto the loading zone portion of the material handling system;
(c) moving the containers loaded in said step (b) proximate to a stocker; and
(d) loading the containers moved to the stocker in said step (c) from the material handling system to the stocker.
